(19) United States
(12) Patent Application Publication
(10) Pub. No.: US 2016/0380992 A1
(43) Pub. Date: Dec. 29, 2016

(54) AUTHENTICATION SPECIFIC DATA

(71) Applicant: GOOGLE INC., Mountain View, CA (US)

(72) Inventor: Aaron Boodman, Mountain View, CA (US)

(73) Assignee: GOOGLE INC., Mountain View, CA (US)

(21) Appl. No.: 15/117,421

(22) PCT Filed: Feb. 11, 2015
(86) PCT No.: PCT/US15/15448

§ 371 Date: Aug. 8, 2016

Related U.S. Application Data
(60) Provisional application No. 61/938,622, filed on Feb. 11, 2014.

(51) Int. Cl. H04L 29/06; G06F 9/455; G06F 17/30

(52) U.S. Cl. CPC H04L 63/08; G06F 17/30899; G06F 17/30321; G06F 17/30867; G06F 9/45558; G06F 2009/45595

(57) ABSTRACT

Methods, systems, and apparatus, including computer programs encoded on a computer storage medium for managing authentications and processing authenitcation specific data. In one aspect, a method includes instantiating an instance of a browsing application ; associating an authentication token with a browser session of the instance of the browsing application; requesting resources from publisher servers, each of the resources being a resource that provides authentication specific information specific to an authentication token, and each resource provides different authentication specific information for each different corresponding authentication token; for each publisher server, authenticating the authentication token for the browser session and receiving the authentication specific information in response; and associating the authentication specific information with only the authentication token; providing the authentication token and its associated authentication specific information to an indexer that indexes the authentication specific information, the resources, and the authentication token in an authentication specific corpus.

### BACKGROUND

The Internet provides access to a wide variety of information. For example, digital image files, video and/or audio files, as well as web page resources for particular subjects or particular news articles, are accessible over the Internet. With respect to web page resources, many of these resources are designed to facilitate the performing of particular functions, such as blogging, booking hotel reservations, shopping, etc. Many of these resources are also personalized in that a user's specific history and user-specific information are shown on the resources when the user establishes an authenticated session with the publisher. For example, an on-line shopping website may show the user's prior product browsing history and current orders; an on-line music store may show the user's currently owned library of music; and so on.

Likewise, with the advent of tablet computers and smart phones, native applications that facilitate the performance of the same functions facilitated by the use of web page resources are now being provided in large numbers. Furthermore, other types of native applications, such as games, may provide user-specific information, such as a user's game history.

A variety of search engines are available for identifying particular resources accessible over the Internet. These search engines crawl and index the various web page resources and native applications. The search engines then uses the index to determine which resources are most responsive to a search query and provides search results that link to the resources in response to the query. Search engines, however, do not crawl or index information specific to users for web pages or native applications.

### SUMMARY

In general, one innovative aspect of the subject matter described in this specification can be embodied in methods that include the actions of: at a data processing apparatus, instantiating an instance of a browsing application; associating an authentication token with a browser session of the instance of the browsing application; requesting resources from publisher servers, each of the resources being a resource that provides authentication specific information specific to an authentication token, and each resource provides different authentication specific information for each different corresponding authentication token; for each publisher server, authenticating the authentication token for the browser session and receiving the authentication specific information in response; and associating the authentication specific information with only the authentication token; providing the authentication token and its associated authentication specific information to an indexer that indexes the authentication specific information, the resources, and the authentication token in an authentication specific corpus. Other embodiments of this aspect include corresponding systems, apparatus, and computer programs, configured to perform the actions of the methods, encoded on computer storage devices.

Another innovative aspect of the subject matter described in this specification can be embodied in methods that include the actions of instantiating, at a first server, a session with a browser application on a user device, the user device being separate from the server; receiving, at the first server and from the user device, a request for an authentication token for the user device and unique to the user device; providing, from first server to the user device, the authentication token; receiving, at the first server and from a publisher server separate from the first server, the authentication token, wherein the authentication token was provided to the publisher server from the user device; authenticating, at the first server the authentication token, and in response providing to the publisher server an authentication notification that authenticates the authentication token. Other embodiments of this aspect include corresponding systems, apparatus, and computer programs, configured to perform the actions of the methods, encoded on computer storage devices.

Another innovative aspect of the subject matter described in this specification can be embodied in methods that include the actions of requesting, by a publisher server, an authentication token from a user device in response to the user device requesting a resource from the publisher server; receiving, at the publisher server and from the user device, the authentication token; providing, from the publisher server to an authentication server, the authentication token, the authentication server being separate from the user device; receiving, from the authentication server, an authentication notification that authenticates the authentication token; and establishing an authenticated session between the publisher server and the user device based on the authentication notification. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. In some implementations, an authentication system does not store personal information that identifies the user; instead, a randomly generated authentication token is provided to the user device and associated with the user device, and the user device provides the authentication token to other websites or applications that require login. The publishers of the websites or applications then provide the authentication token to the authentication system for authentication. Thus, the identity of the user can be shielded from the authentication system.

In other implementations in which the authentication token is tied to a user account, the authentication system can be used to verify the user account to publishers, and the publisher can then automatically login a user using publisher-side login credentials. Thus, the different login credentials of the user for different sites can be shielded from the authentication system, yet the user can still be automatically and safely logged into various sites that each use different login credentials.

A search system can generate virtual machine instances and use the authentication tokens to receive and index resources and application page data that include authentication-specific information. When a user searches for information, the search engine, in addition to searching a general web corpus index, also searches an authentication specific corpus index. The search of the authentication specific corpus index is constrained to data that is tied to the authentication token(s) associated with a user account or user device for which the search query was received. Accordingly, a user may be presented with authentication-specific information for the user in search results, in addition to general search results. Search operations are thus more likely to satisfy a user's informational need.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which authentication-specific data are indexed and searched.

FIG. 2 is a system diagram of an example authentication data flow.

FIG. 3 is a flow diagram of an example authentication process.

FIG. 4 is a system diagram of an example authentication-specific crawling and indexing data flow.

FIG. 5 is a flow diagram of an example process for crawling and indexing authentication-specific data.

FIG. 6 is a flow diagram for providing authentication-specific data in response to a search query.

FIG. 7 is an illustration of a search results page with an authentication-specific search result.

Like reference numbers and designations in the various drawings indicate like elements.

### DETAILED DESCRIPTION

Overview

A search system utilizes an authentication system to establish, for each user account (or, optionally, each user device), user sessions for resources and applications that require user logins. The authentication system generates a persistent token for a user device. The token may be specific to the user device, or may be specific to a user account. In the former case a unique token is provided to each user device; if the same user is using two different user devices, the tokens may be associated with a user account for that user. In the latter case, the same token may be provided to multiple user devices when a user presents login credentials to the authentication system.

The authentication tokens can be provided to publishers to facilitate user logins for publisher websites. The authentication system, by use of a back-end process between the publishers and the authentication system, is shielded from user login credentials to protect the user's privacy. The authentication system facilitates automatic logins of browsers and native applications, such as shopping apps, music apps, and the like. In some implementations, an authentication system does not store personal information that identifies the user; instead, a randomly generated authentication token is provided to the user device, and the user device provides the authentication token to other websites or applications that require logins. The publishers of the websites or applications then provide the authentication token to the authentication system for authentication. Upon receiving information that the authentication token is authenticated, the publishers may automatically login the users.

In other implementations in which the authentication token is tied to a user account, the authentication system can be used to verify the user account to publishers, and the publisher can then automatically login a user using publisher-side login credentials. The publisher-side login credentials may be the user's login credentials (e.g., a user name and password) or may be a separate set of login credentials reserved specifically for logins by use of the authentication token.

A search system in communication with the authentication system can use the authentication system to crawl and index authentication-specific information. The search system generates virtual machine instances of user devices and uses, for each of a plurality of user accounts, corresponding authentication tokens to receive and index resources and application page data that include authentication-specific information for users of the user accounts. Thereafter, when a user searches for information, the search engine, in addition to searching a general web corpus index, also searches an authentication-specific corpus index. The search of the authentication specific corpus index is constrained to data that is tied to the authentication token(s) associated with a user account for which the search query is received. The user is presented with general search results and authentication-specific information for the user in authentication-specific search results.

The user may further instruct the search engine to not index authentication-specific information for the user if the user desires that such information not be crawled and indexed. Furthermore, each publisher may be required to specify resources and applications to be crawled and indexed for authentication-specific information. Failure to specify such resources and applications will result in the resources and applications not being crawled for such authentication-specific information.

These features and additional features are described in more detail below.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Example Operating Environment

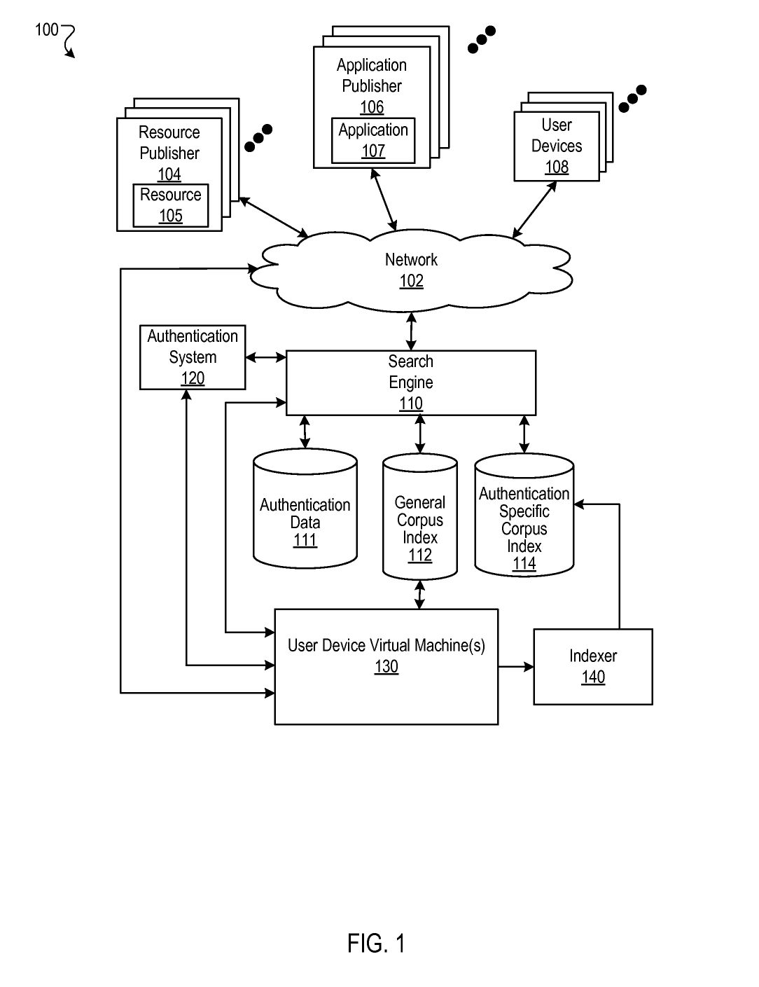

FIG. 1 is a block diagram of an example environment 100 in which authentication-specific data are indexed and searched. A computer network 102, such as the Internet, connects resource publisher web sites 104, application publishers 106, user devices 108 and a search engine 110. An authentication system 120, user device virtual machines 130 and an indexer 140 also facilitate the crawling and indexing of authentication-specification information. The authentication system 120 can also be used to facilitate automatic logins of users to various websites and applications, as will be described in more detail below.

A resource publisher website 104 includes one or more web resources 105 associated with a domain and hosted by one or more servers in one or more locations. Generally, a resource publisher website is a collection of web pages formatted in hypertext markup language (HTML) that can contain text, images, multimedia content, and programming elements. Each website 104 is maintained by a content publisher, which is an entity that controls, manages and/or owns the website 104.

A web page resource is any data that can be provided by a publisher website 104 over the network 102 and that has a resource address, e.g., a uniform resource locator (URL). Web resources may be HTML pages, images files, video files, audio files, and feed sources, to name just a few. The resources may include embedded information, e.g., meta information and hyperlinks, and/or embedded instructions, e.g., client-side scripts.

An application publisher website 106 may also include one or more web resources 105, and also provides native applications 107. A native application 107 is an application specifically designed to run on a particular user device operating system and machine firmware. As used in this specification, an “application page” is a particular display environment within a native application and in which is displayed content, such as text, images, and the like. An application page is specific to the particular native application, and the native application is specific to the particular operating system of the user device 108. An application page differs from a rendered web resource in that the application page is generated within and specific to the native application, while a web resource may be rendered in any browser for which the web page resource is compatible, and is independent of the operating system of the user device.

A user device 108 is an electronic device that is under the control of a user. A user device 108 is typically capable of requesting and receiving web page resources 104 and native applications 107 over the network 102. Example user devices 108 include personal computers, mobile communication devices, and tablet computers.

To search web resources 105 and the native applications 107, the search engine 110 accesses a general corpus index 112 and an authentication-specific corpus index 114. The general corpus index 112 is an index of web resources 105 and native application 107 page data. The authentication-specific corpus index 114 is an index of authentication-specification information from resources 105 and application pages for native applications 107, and is constructed using virtual machines 130 and an indexer 140. Although shown as separate indexes, the general corpus index 112 and the authentication-specific corpus index 114 can be combined in a single index. As used herein, authentication-specific information or data is information that that is different for each user, and that is provided only in response to the establishment of a session authenticated for a user with a publisher. An example of authentication-specific information is shopping history information and current orders for a user provided by a retailer website webpage, such as an “account information” webpage; data describing a library of songs currently owned by a user and purchased from an on-line media seller; and the like.

The user devices 108 submit search queries to the search engine 110. In response to each query, the search engine 110 accesses the general corpus index 112 and the authentication-specific corpus index 114 to identify general information and authentication-specific information, respectively, that are relevant to the query. The search engine 110 may, for example, identify the resources and applications in the form of general search results and authentication-specific search results, respectively. Once generated, the search results are provided to the user device 108 from which the query was received.

The search results may include web resource search results and native application search results. A web resource search result is data generated by the search engine 110 that identifies a web resource and provides information that satisfies a particular search query. A web resource search result for a resource can include a web page title, a snippet of text extracted from the resource, and a resource locator for the resource, e.g., the URL of a web page. A native application search result specifies a native application, and a variety of functions can be invoked by the selection of an application search result. For example, selection of a native application search result may cause the native application to launch (if installed on the user device 108) and generate an instance of application page referenced in the application search result and that includes content that is relevant to the search query. Such a function is referred to as “deep linking” within the application search result.

Authentication

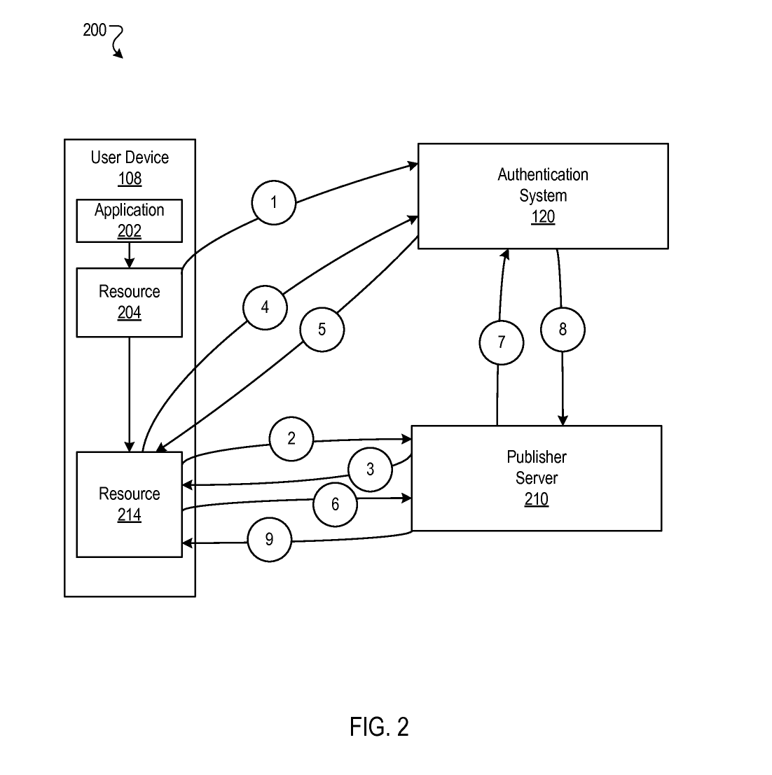

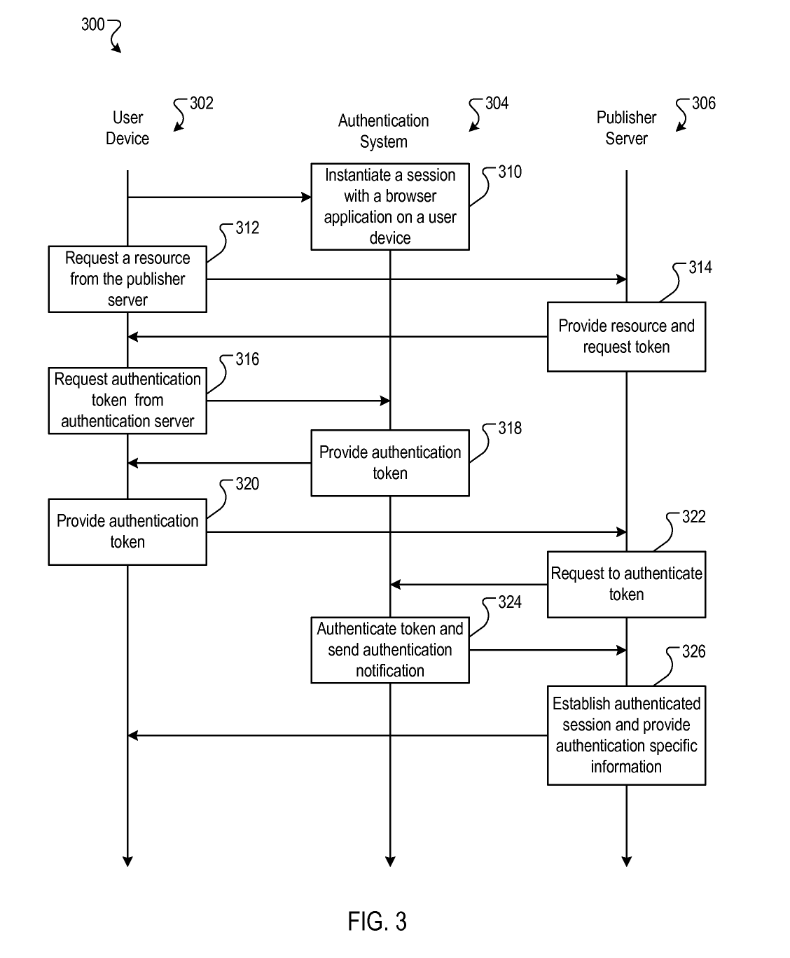

The authentication system 120 also facilitates automatic logins of browsers and native applications, such as shopping apps, music apps, and the like. FIG. 2 is a system diagram 200 of an example authentication data flow. The data flow of FIG. 2 is also described with reference to FIG. 3, is a flow diagram of an example authentication process 300. The process 300 is divided into sub-processes 302, 304, and 306 that take place at the user device, authentication server, and the publisher server, respectively.

At 310, the authentication system 120 instantiates a session with an application 202 on a user device. This is represented by flow element 1 in FIG. 2. The application may be a browser, or a native application that sends and receives data over a network, such as a video game, a shopping app, and the like. For this example, a browser is the application 202.

The browser may include a “log in” button on an initial resource 204 when initially loaded. The user may provide his or her login credentials to the authentication system 120. One example is the use of a web browser associated with a search engine that includes the authentication system. Once the user logs in, the sessions is created for the user device 108. The session may be based on the device itself, or, alternatively, may be based on a user account that may transfer from one device to another. In some implementations, the session may be persistent in that the session may last indefinitely, or for several months. In these situations the session is not cookie-based, nor is the resulting authentication token. For example, the user device may provide a unique identifier, e.g., a MAC address, or a serial number uniquely associated with the browser, and thus whenever the user again activates the browser the user may be “automatically” logged in by the authentication system 120, whether or not the user is actually “logged in” to a user account. In variations of this implementation, the user may be required to log into the authentication system 120 after logging out, such as may occur when a user manually logs out. As will be described in more detail below, this step, represented by flow element 1, is optional and can be done at a later time.

At 312, the user device 108 requests a resource 214 from the publisher server 210. This is represented by flow element 2 of FIG. 2. If the resource is one for which a user may provide login credentials, the publisher 210 can provide the resource with an instruction that requests an authentication token for the user. The authentication token can be used to log in the user without requiring the user to provide user credentials specific to the publisher. Assuming the publisher supports the authentication process, the publisher 210 augments its user account data with an authentication token field for each user account. The authentication token, once received and authenticated, can then be used to establish an authenticated session (e.g., a session that provides information specific to a user for which the session is authenticated).

In some implementations, the publisher 210, by use of a script API, may request the authentication token from the browser for each request. In other implementations, the browser is configured to provide header information with the request to notify the publisher 210 that the publisher may request the authentication token. In the latter case, the resource is provided with the instruction that causes the browser on the user device to provide the authentication token.

At 314, the publisher server provides the resource 214 to the user device and requests the token from the user device 108. This is represented by flow element 3 of FIG. 2. If the user device 108 has the token stored locally, then the user device 108 will provide the token to the publisher 210. However, assume the user device does not have the authentication token stored locally; in such a situation, the user device 108 will request the token from the authentication system 108.

At 316, the user device 108 requests the authentication token from authentication system 120. This is represented by flow element 4. The authentication system 210 will receive the request and determine if a session is established. If a session is not established (e.g., the flow element 1 of FIG. 2 was skipped), then the authentication system 120 can request the user log in to the authentication system 120 using authentication credentials specific to the authentication system 120. If a session was previously established but the user logged out, the authentication system can use a device identifier or a browser identifier to access the authentication token associated with the user device.

At 318, the authentication system 120 provides the authentication token to the user device 108. This is represented by flow element 5. Thereafter, at 320, the user device 108 provides the authentication token to the publisher server 210, as represented by flow element 6.

At 322, the publisher server 210 then requests the authentication system 120 to authenticate the authentication token. This is represented by flow element 7. The publisher server 210 sends the authentication token to the authentication system 120, and the authentication system 120 looks up the token. Provided the token is valid, it is authenticated.

At 324, the authentication system 120 authenticates the token and sends an authentication notification to the publisher server 210. This is represented by flow element 8. The publisher server 210 then, at 326, establishes an authenticated session and provides authentication specific information, as represented by flow element 9.

The authentication session of the publisher 108 can be established several ways. In one example, the publisher server 210 will store the authentication token with user access credentials that are specific to the publisher server 210. If the authentication token is already stored at the publisher server 210, the user may be automatically logged in under the user's credentials. If, however, the authentication token is not stored at the publisher server 210, then the publisher server 210 may request the user to login using the user's credentials and the associate the user's credentials with the authentication token. This latter case may occur when the user is logging in to the publisher server 210 for the first time, such as when the user establishes an account; or when the user is logging in to the publisher server 210 for the first time by use of the authentication token; or when the authentication server 210 issues a new authentication token to the user, e.g., in the even that a previously issued authentication token has expired.

In the example described above, one authentication token is used for a user device for one publisher server. The same authentication token can be used for different publisher servers, and thus once the user device has the authentication token stored locally, it need not go back to the authentication 120 system unless the authentication token has expired. In other implementations, a unique authentication token can be generated for the user device for each publisher server. In these implementations, the user device (or user account) is associated with multiple authentication tokens, each uniquely associating the user device and one publisher.

The authentication token can be a randomly generated value, or some other value that is uniquely associated with the user device, or, alternatively, a user account.

Crawling And Indexing Authentication-Specific Information

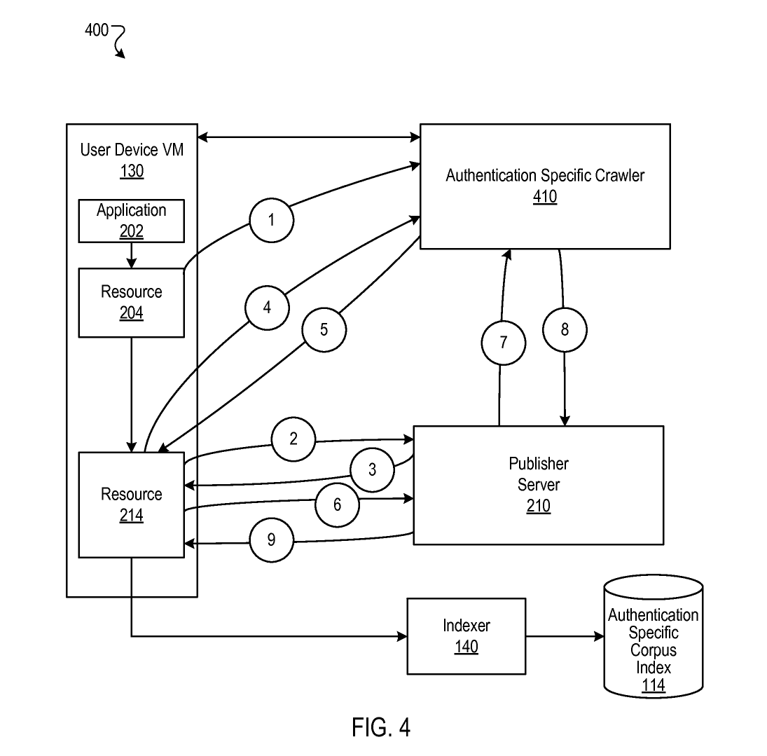

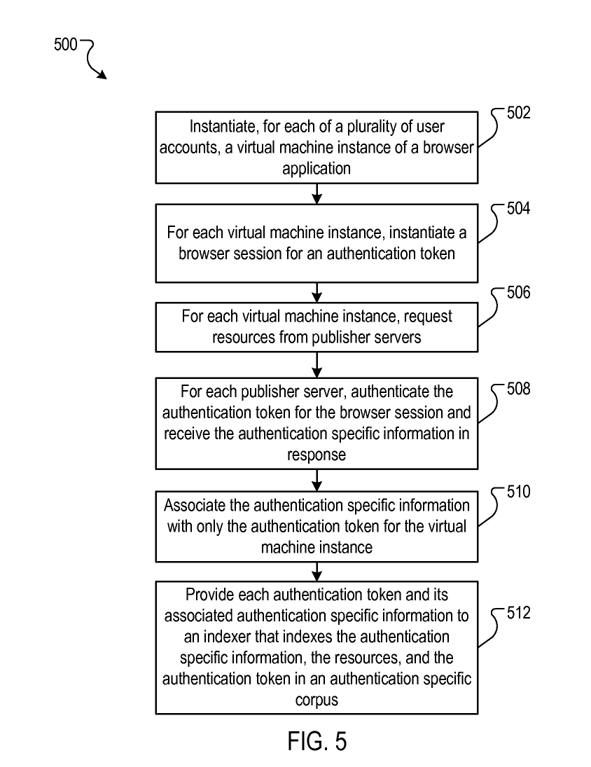

FIG. 4 is a system diagram 400 of an example authentication-specific crawling and indexing data flow. The data flow is described with reference to FIG. 5, which is a flow diagram of an example process 500 for crawling and indexing authentication-specific data. The process 500 can be used in a search system that incorporates the authentication specific crawler 310 and instantiates the virtual machine instances 130.

The process 500 instantiates, for each of a plurality of user accounts, a virtual machine instance of an application 202 (502). For example, the authentication specific crawler 410 instantiates the virtual machines, and launches a browser in each machine. Other applications as described above can also be instantiated. This process step is similar to step 310 of FIG. 3; however, the authentication specific crawler 310 creates the session and causes the authentication system 110 to issue an authentication token. The authentication token that is issued is one that has been previously issued for an actual user device or user account.

The process 500, for each virtual machine instance, instantiates a browser session for an authentication token (504). This is represented by flow element 1 in FIG. 4, and is similar to the establishment of a session as described in FIG. 2. However, as described above, the authentication specific crawler 310 creates the session and causes the authentication system 110 to issue an authentication token.

The process 500, for each virtual machine instance, requests resources from publisher servers (506). In FIG. 3, an example resource 214 is requested from the publisher 210, as illustrated by process flow 2. The resources that are requested are, in some implementations, only resources previously requested by requests associated with the authentication token. The virtual machine 130 and the publisher server 210 may thereafter perform the necessary steps to request the authentication token as described with reference to FIG. 2 above. However, because the authentication specific crawler 310 does not have access to user credentials for logging into the publisher server 210, sessions are only established for publisher servers 210 for which authenticated sessions have previously been established by a user and for which a device used by the user can be automatically logged in using a corresponding authentication token.

The process 500, for each publisher server, authenticates the authentication token for the browser session and receives the authentication specific information in response (508). This is represented by flow elements 7, 8, and 9 in FIG. 4, and is similar to the steps taken for flow elements 7, 8 and 9 in FIG. 2.

The process 500 associates the authentication specific information with only the authentication token for the virtual machine instance (510). For example, as shown in FIG. 4, authentication specific information is provided for the resource 214. Examples of authentication specific information may be a list of songs and videos in a user's digital library from a digital media provider; a list of prior orders and current orders for the user in the user's account for an online retailer; a user's list of virtual items, experience, and other user information for an online gaming environment; and so on.

The process 500 provides each authentication token and its associated authentication specific information to an indexer 140 that indexes the authentication specific information, the resources, and the authentication token 114 in an authentication specific corpus (512). The indexer 140 and the corpus index 114 are maintained by a search system. Any appropriate indexing process may be used.

By use of the process 500 of FIG. 5, a search system may then provide users with the ability to search authentication-specific information that is specific to the user. Because the search is constrained by authentication tokens, only the user's authentication-specification information is available to the user, and authentication-specific information for other authentication tokens not associated with the user will not be provided to the user.

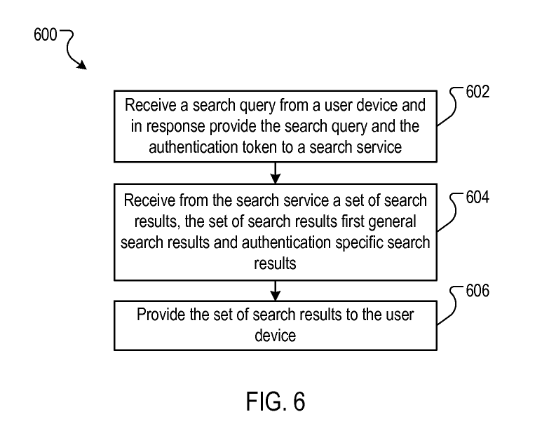

FIG. 6 is a flow diagram of an example process 600 for providing authentication-specific data in response to a search query. The process 600 can be used in a search system.

The process 600 receives a search query from a user device and in response provides the search query and the authentication token to a search service (602). For example, a user device may provide a query through a search interface. The query may be provided with the authentication token, or the search system may use an identifier, such as a user account if the user is logged into an account maintained by the search system, or a device identifier, or a browser identifier, to obtain the corresponding authentication token.

The process 600 receive from the search service a set of search results, the set of search results including general search results and authentication specific search results (604). The general search results identify first resources indexed in a general resource corpus index 112, and the authentication specific search results identify resources and authentication-specific information indexed in the authentication specific corpus index 114. The authentication specific search results are generated in response to a search constrained to only the authentication specific information associated with the authentication token. A variety of appropriate search processing algorithms can be used.

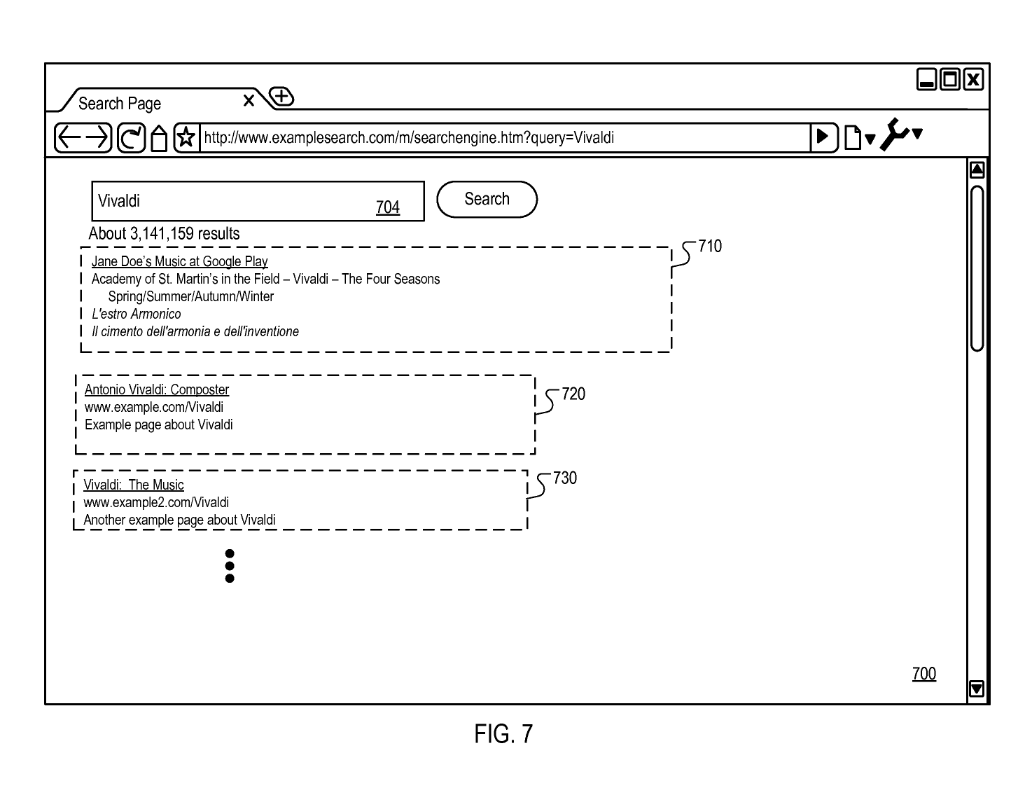

The process 600 provides the set of search results to the user device (606). The search results are then displayed on the user device. One such example display is shown in FIG. 7, which is an illustration of a search results page 700 with an authentication-specific search result 720. Displayed in the search results page 700 are search results 710,720 and 730, each of which identify information responsive to the query “Vivaldi” displayed in the search input field 704. The search result 710 lists a portion of a user's library of purchased music. Because the user has purchased three compositions composed by Vivaldi, the three compositions are listed in the authentication-specific search result 710. Two other search results 720 and 730 identify data indexed in the general corpus index 112 that are responsive to the query.

Had another user issued the same query, and the other user had purchased different Vivaldi compositions from a different media provider, the authentication specific search result 710 would list the different compositions and the different provider for that user.

Other types of authentication-specific search results can also be provided. For example, for an application that provides application-specific pages, such as a game app, or a shopping app, the set of search results can include results identifying application specific pages indexed in the authentication specific corpus index 114. The application specific result may include a URI that deep links into the application, and selection of an application specific result can cause the application to launch and invoke the particular application specific page.

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer implemented method, comprising:
at a data processing apparatus, instantiating an instance of a browsing application;
associating an authentication token with a browser session of the instance of the browsing application;
requesting resources from publisher servers, each of the resources being a resource that provides authentication specific information specific to an authentication token, and each resource provides different authentication specific information for each different corresponding authentication token;
for each publisher server, authenticating the authentication token for the browser session and receiving the authentication specific information in response; and
associating the authentication specific information with only the authentication token;
providing the authentication token and its associated authentication specific information to an indexer that indexes the authentication specific information, the resources, and the authentication token in an authentication specific corpus.

2. The method of claim 1, wherein:
instantiating an instance of a browsing application comprises generating, for each of a plurality of user devices, a virtual machine instance of a browsing application;
associating an authentication token with a browser session of the instance of the browsing application comprises, for each virtual machine instance, instantiating a browser session for a corresponding authentication token, each authentication token uniquely corresponding to a user device;
requesting resources from publishing servers comprises, for each virtual machine instance, requesting resources from the publisher servers;
associating the authentication specific information with only the authentication token comprises, for each virtual machine instance, associating the authentication specific information with only the authentication token for the virtual machine instance; and
providing the authentication token and its associated authentication specific information to an indexer comprises providing each authentication token and its associated authentication specific information to an indexer that indexes the authentication specific information, the resources, and the authentication token in an authentication specific corpus.

3. The method of claim 2, further comprising:
instantiating, at the data processing apparatus, a session with a browser application on a user device;
determining an authentication token for the session;
receiving a search query from the user device and in response providing the search query and the authentication token to a search service;
receiving, from the search service, a set of search results, the set of search results including:
first search results identifying first resources indexed in a general resource corpus, the first resources identified by the search service searching the general resource corpus; and
second search results identifying second resources indexed in the authentication specific corpus, the second resources identified by the search service searching the authentication specific corpus by a search constrained to only the authentication specific information associated with the authentication token; and
providing the set of search results to the user device in response to the query.

4. The method of claim 2, further comprising, for two or more of the virtual machine instances:
instantiating, within the virtual machine, a native application that generates application pages for display on a user device within the native application, the native application operating independent of a browser application that can operate on the user device;
authenticating the authentication token for the native application;
accessing, within the virtual machine, application pages of the native application, and for each of the application pages receiving authentication specific information for the application page, wherein the application pages provide different authentication specific information for each authentication token;
providing the authentication token, application page identifiers and their associated authentication specific information from the application pages, to an indexer that indexes the application page identifiers, their associated authentication specific information, and the authentication token in the authentication specific corpus

5. The method of claim 4, wherein the set of search results further includes third search results identifying application specific pages indexed in the authentication specific corpus, the application specific pages identified by the search service searching the authentication specific corpus by a search constrained to only the authentication specific information associated with the authentication token.

6. The method of claim 2, wherein, for each publisher server, authenticating the authentication token for the browser session and receiving the authentication specific information in response comprises:
providing the authentication token to the virtual machine instance of the browser application;
providing, from the virtual machine instance of the browser application, the authentication token to the publisher server;
receiving, from the publisher server, the authentication token and a request to authenticate the authentication token; and
authenticating the authentication token, and in response providing to the publisher server an authentication notification that authenticates the authentication token.

7. The method of claim 2, wherein each authentication token is further specific to each publisher server, and wherein a plurality of authentications token are associated with a user account.

8-15. (canceled)

16. A system, comprising:
a data processing apparatus; and
a memory storage device storing instructions executable by the data processing apparatus and that upon such execution cause the data processing apparatus to perform operations comprising:
generating, for each of a plurality of user devices, a virtual machine instance of a browsing application;
for each virtual machine instance:
instantiating a browser session for an authentication token, each authentication token uniquely corresponding to a user device;
requesting resources from publisher servers, each of the resources being a resource that provides authentication specific information specific to an authentication token, and each resource provides different authentication specific information for each authentication token;
for each publisher server, authenticating the authentication token for the browser session and receiving the authentication specific information in response; and
associating the authentication specific information with only the authentication token for the virtual machine instance;
providing each authentication token and its associated authentication specific information to an indexer that indexes the authentication specific information, the resources, and the authentication token in an authentication specific corpus.

17. A memory storage device storing instructions executable by the data processing apparatus and that upon such execution cause the data processing apparatus to perform operations comprising:
generating, for each of a plurality of user devices, a virtual machine instance of a browsing application;
for each virtual machine instance:
instantiating a browser session for an authentication token, each authentication token uniquely corresponding to a user device;
requesting resources from publisher servers, each of the resources being a resource that provides authentication specific information specific to an authentication token, and each resource provides different authentication specific information for each authentication token;
for each publisher server, authenticating the authentication token for the browser session and receiving the authentication specific information in response; and
associating the authentication specific information with only the authentication token for the virtual machine instance;
providing each authentication token and its associated authentication specific information to an indexer that indexes the authentication specific information, the resources, and the authentication token in an authentication specific corpus.

18-21. (canceled)
